(19) United States
(12) Patent Application Publication
(10) Pub. No.: US 2009/0254444 A1
(43) Pub. Date: Oct. 8, 2009

(54) COMMODITY SALES DATA PROCESSING APPARATUS AND COMPUTER-READABLE RECORDING MEDIUM

(75) Inventor: Masayoshi Harada, Shizouka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/418,882

(22) Filed: Apr. 6, 2009

(30) Foreign Application Priority Data
Apr. 8, 2008 (JP) 2008-099940

(51) Int. Cl. G07G 1/12; G06Q 10/00

(52) U.S. Cl. 705/18; 705/30

(57) ABSTRACT

A controller of a commodity sales data processing apparatus outputs, in response to closing operation for one transaction or bill exchange operation for instructing bill exchange, an opening command to a cash storing unit, which can be freely opened and closed to store cash and opens according to the opening command, to open the cash storing unit. The controller prohibits the opening of the cash storing unit when the bill exchange operation in the operation input unit is performed regardless of a state in which the one transaction is suspended.

### CROSS REFERENCE TO RELATED APPLICATION

This application is based upon and claims the benefit of priority from Japanese Patent Application No. 2008-99940, filed on Apr. 8, 2008, the content of which is incorporated herein by reference.

### TECHNICAL FIELD

The present invention relates to a commodity sales data processing apparatus such as a POS (Point Of Sales) terminal and a computer-readable recording medium that stores a computer program installed in a computer of the commodity sales data processing apparatus, and, more particularly to a technique that can prevent an illegal act of an operator embezzling money using a POS terminal or the like.

### BACKGROUND

Conventionally, there is a POS terminal in which a drawer can be opened for bill exchange. In the POS terminal of this type, an operator (a cashier, hereinafter referred to as cashier) can intentionally open the drawer and steal money from the drawer.

Therefore, a technique for suppressing the illegal act is developed. As an example of the technique, JP-A-9-161154 discloses a technique for accumulating and storing, when operation that could be a target of an illegal act such as bill exchange is performed, an operation code for identifying an item of the operation and data generated by the operation together with an operator code for specifying an operator. As another example, JP-A-8-315250 discloses a technique for printing and recording, when suspension of a transaction is declared by operation of a registration suspension key before a closing key is operated, a message such as “registration suspended” on a journal sheet, also printing the message on a receipt sheet, and issuing the receipt sheet as a registration suspension receipt. JP-A-8-315250 also describes that, when the suspension of a transaction is declared, a count value is updated and identification data of the count value is printed on the registration suspension receipt to secure traceability of the registration suspension receipt.

However, the essence of the techniques explained above is traceability for an illegal act. Therefore, an illegal act that could actually occur cannot be prevented on the spot.

### SUMMARY

It is an object of the present invention to prevent embezzlement of money by a cashier.

According to an aspect of the present invention, there is provided a commodity sales data processing apparatus including: a commodity-data input unit for inputting data concerning a commodity; an operation input unit for inputting data; a first data storing unit that stores data; a second data storing unit that saves data; and a controller that executes processing for outputting, in response to opening operation in the operation input unit, an opening command to a cash storing unit that can be freely opened and closed to store cash and opens according to the opening command, storing, in the first data storing unit, transaction data for one transaction corresponding to input operation in the commodity-data input unit, saving, when the one transaction is concluded, the transaction data stored in the first data storing unit in the second data storing unit as sales data, saving, when the one transaction is suspended, the transaction data stored in the first data storing unit in the second data storing unit as transaction non-conclusion data, and prohibiting opening of the cash storing unit when opening operation is performed in the operation input unit in a state in which the one transaction is suspended.

According to another aspect of the present invention, there is provided a computer-readable medium having a computer program stored thereon that, when executed by a computer, causes the computer to: output, in response to opening operation in an operation input unit for inputting data, an opening command to a cash storing unit that can be freely opened and closed to store cash and opens according to the opening command; store, in a first data storing unit that stores data, transaction data for one transaction corresponding to input operation in a commodity-data input unit for inputting data concerning a commodity; save, when the one transaction is concluded, the transaction data stored in the first data storing unit in a second data storing unit, which saves data, as sales data; save, when the one transaction is suspended, the transaction data stored in the first data storing unit in the second data storing unit as transaction non-conclusion data; and prohibit opening of the cash storing unit when opening operation is performed in the operation input unit in a state in which the one transaction is suspended.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram of a configuration of a commodity sale data processing system according to an embodiment of the present invention;

FIG. 2 is a block diagram of a hardware configuration of a POS terminal according to the embodiment;

FIG. 3A is a schematic diagram of a main memory area of a transaction memory (a second data storing unit) secured in a RAM of the POS terminal according to the embodiment;

FIG. 3B is a schematic diagram of a main memory area of a temporary storage buffer (a first data storing unit) secured in the RAM of the POS terminal according to the embodiment;

FIG. 3C is a schematic diagram of a main memory area of an illegal operation storage memory (the second data storing unit) secured in the RAM of the POS terminal according to the embodiment;

FIG. 4 is a flowchart of an example of operations executed by a CPU of the POS terminal according to the embodiment in a registration mode;

FIG. 5 is a flowchart of operations in an adjustment mode of the POS terminal according to the embodiment; and

FIG. 6 is a flowchart of another example of operations executed by the CPU of the POS terminal according to the embodiment in the registration mode.

### DETAILED DESCRIPTION

An embodiment of the present invention relates to a commodity sales data processing system including a POS terminal equipped with a drawer. The commodity sales data processing system is installed in a convenience store, a supermarket, and the like. The POS terminal according to this embodiment can prevent an illegal act of embezzlement of money by a cashier. When the cashier performs illegal operation, the POS terminal stores illegal operation information in a POS terminal main body or a host store server to make it possible to check an illegal act later.

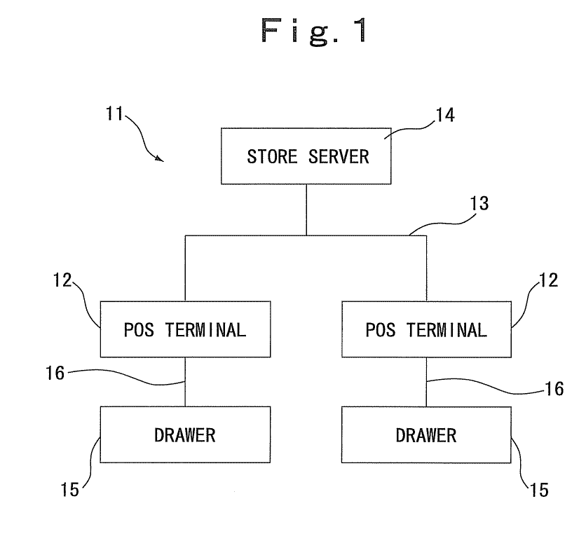

FIG. 1 is a schematic diagram of a commodity sales data processing system according to this embodiment. A commodity sales data processing system 11 includes plural POS terminals 12 as commodity sales data processing apparatuses and a store server 14 as a commodity sales data managing apparatus connected to the POS terminals 12 to be capable communicating with each other via a communication line 13 such as a LAN (Local Area Network). Drawers 15 as cash storing units are connected to the POS terminal 12 by communication cables 16. The drawers 15 store both bills and coins.

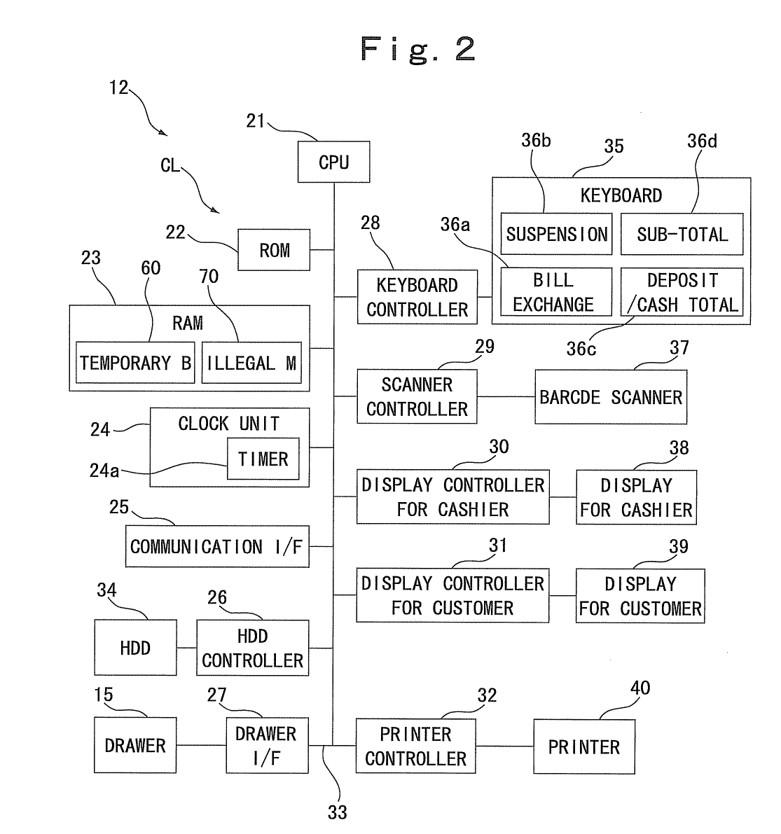

FIG. 2 is a block diagram of a hardware main part configuration of the POS terminal 12. In the POS terminal 12, to a CPU (Central Processing Unit) 21 that controls respective units of the POS terminal 12, a ROM (Read Only Memory) 22 having stored therein in advance stationary data such as a control program executed by the CPU 21 and a RAM (Random Access Memory) 23 in which various memory areas for storing variable data are formed are connected via a bus line 33. The CPU 21, the ROM 22, and the RAM 23 configure a controller CL. The RAM 23 includes an SRAM functioning as a first data storing unit that stores data and a nonvolatile memory functioning as a second data storing unit that saves data. A battery backup memory, an EEPROM, a flash memory, and the like can be used as the nonvolatile memory.

In the POS terminal 12, a clock unit 24 that measures present date and time, a communication interface 25, an HDD (Hard Disk Drive) controller 26, a drawer interface 27, a keyboard controller 28, a scanner controller 29, a display controller for shop 30, a display controller for customer 31, and a printer controller 32 are connected to the controller CL via the bus line 33. The communication interface 25 connects the POS terminal 12 to the store server 14 via the communication line 13.

The POS terminal 12 connects an HDD 34, the drawer 15, a keyboard 35, a barcode scanner 37, a display for cashier 38, a display for customer 39, and a printer 40 to the controller CL via the HDD controller 26, the drawer interface 27, the keyboard controller 28, the scanner controller 29, the display controller for shop 30, the display controller for customer 31, and the printer controller 32, respectively. The display for cashier 38 and the printer 40 function as a warning unit.

The controller CL of the POS terminal 12 recognizes identification data of a commodity obtained by the barcode scanner 37, which is connected to the scanner controller 29, scanning and decoding a barcode and outputting the barcode as a commodity code. Therefore, the barcode scanner 37 functions as a commodity-data input unit. The keyboard 35 is used for inputting commodity codes and inputting various instructions and commands. Therefore, the keyboard 35 functions as both the commodity-data input unit for inputting data concerning a commodity and an operation input unit for inputting data.

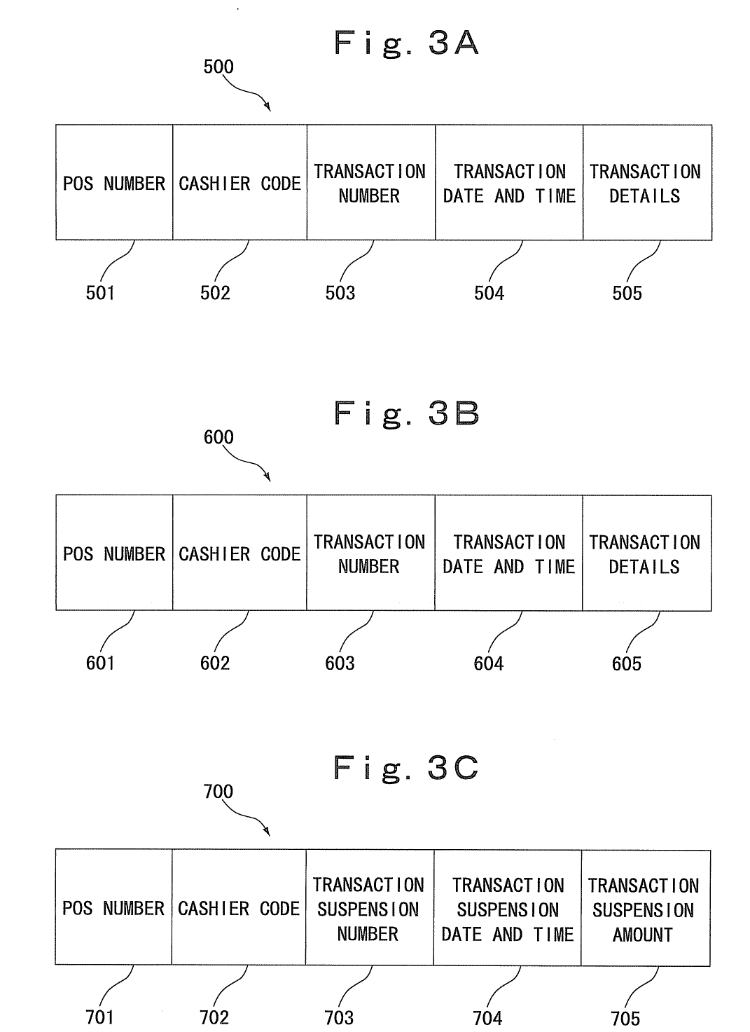

FIG. 3A is a schematic diagram of a main memory area of a transaction memory 500 (the second data storing unit) secured in the RAM 23. In the RAM 23, an area for the transaction memory 500 (a journal memory) as the second data storing unit is secured. The transaction memory 500 has, as shown in FIG. 3A, a cashier code area 502, a transaction number area 503, a transaction date and time area 504, and a transaction detail storage area 505 in association with a POS number area 501.

The POS number area 501 stores a terminal number as data for specifying the POS terminal 12 allocated to each of shops. The POS number area 501 may store not only the terminal number but also a sign, a setting place name, and the like other than the terminal number for specifying the POS terminal 12 and specify the POS terminal 12 using the sign, the setting place name, and the like. The cashier code area 502 stores a cashier code as data for specifying a cashier who performs sign-on input for operating the POS terminal 12 specified by the POS number area 501. The cashier code area 502 may store not only the cashier code but also a cashier name for specifying a cashier and specify the cashier using the cashier name. The transaction number area 503 stores a transaction number (a receipt number) for specifying a commodity sales transaction processed by the POS terminal 12 specified by the POS number area 501. The transaction date and time area 504 stores, for each transaction number specified by the transaction number area 503, transaction date and time of one transaction indicated by transaction number. The transaction date and time is measured by the clock unit 24. The transaction detail storage area 505 stores, for each transaction number specified by the transaction number area 503, transaction details of one transaction indicated by the transaction number. The transaction memory 500 functions as an electronic journal. The electronic journal according to this embodiment saves not only sales data of a concluded commodity transaction but also transaction non-conclusion data obtained when transaction suspension operation is performed. In this case, the transaction non-conclusion data is not handled as sales data and is stored separately from sales data.

FIG. 3B is a schematic diagram of a main memory area of a temporary storage buffer 600 (the first data storing unit) secured in the RAM 23. The RAM 23 also includes the temporary storage buffer 600 (see FIG. 2) as the first data storing unit in which a commodity sales transaction is temporarily stored before being stored in the transaction memory 500. The temporarily storage buffer 600 has, in association with a POS number area 601, a cashier code area 602, a transaction number area 603, a transaction date and time area 604, and a transaction detail storage area 605. Data stored in the temporarily storage buffer 600 correspond to the transaction memory 500. Therefore, explanation of the data is omitted.

FIG. 3C is a schematic diagram of a main memory area of an illegal operation storage memory (the second data storing unit) secured in the RAM 23. In the RAM 23, an area for an illegal operation recording memory 700 (see FIG. 2) as the second data storing unit is secured. When bill exchange operation (depression of a bill exchange key 36a) is performed following transaction suspension operation (depression of a transaction suspension key 36b) explained later, the controller CL determines that illegal operation is performed and saves various data input during the illegal operation in the illegal operation recording memory 700. As shown in FIG. 3C, the illegal operation recording memory 700 has a cashier code area 702, a transaction suspension number area 703, a transaction suspension date and time area 704, and a transaction suspension amount area 705 in association with a POS number area 701.

The POS number area 701 stores a terminal number of the POS terminal 12 in which bill exchange operation is performed after transaction suspension operation. The cashier code area 702 stores a cashier code as an operator code for specifying a cashier who operates the POS terminal 12, in which the bill exchange operation is performed after the transaction suspension operation, to perform the bill exchange operation after the transaction suspension operation. The transaction suspension number area 703 stores a transaction number (a receipt number) issued at the start of a transaction subjected to transaction suspension processing. The transaction suspension date and time area 704 stores, as an example, transaction date and time of the transaction for which the bill exchange operation is performed after the transaction suspension operation and, as another example, date and time when the bill exchange operation is performed after the transaction suspension operation. The transaction suspension amount area 705 stores a total amount of the transaction subjected to the transaction suspension processing.

Details of the keyboard 35 are explained below. The keyboard 35 includes, besides various keys such as a sign-on key, a sign-off key, a commodity key, a register key, a multiplication key, a PLU key, a clear key, and a transaction detail key (all of which are not shown in the figure), the bill exchange key 36a, the transaction suspension key 36b, a deposit and cash total key 36c, and a sub-total key 36d.

The sign-on key is used for designating execution of sign-on (declaration for starting commodity input) and specifying a cashier who operates the POS terminal 12. The cashier depresses the sign-on key after inputting a cashier code for specifying the cashier. When the depression of the sign-on key is determined, the controller CL executes sign-on and temporarily stores the input cashier code in the cashier code area 502 of the transaction memory 500.

The sign-off key is used when execution of sign-off is instructed and the cashier who operates the POS terminal 12 changes. When the controller CL determines that the sign-off key is depressed, the controller CL executes sign-off and clears the cashier code temporarily stored in the cashier code area 502 of the transaction memory 500.

The commodity key is used to input, for example, commodities (vegetables, fruits, side dishes, etc.) without barcodes.

The register key has a function of registering and inputting numerical value data of numbers 0 to 9 of a deposit amount or the like.

The sub-total key 36d has a function of declaring the end of input of commodities in one transaction and instructing calculation of a total amount of the input commodities.

The deposit and cash total key 36c has a function as a closing key for declaring closing of a transaction when the cashier depresses the deposit and cash total key 36c after registering cash paid by a customer as one transaction. The depression of the deposit and cash total key 36c means declaration of conclusion of a transaction of transaction data temporarily stored in the temporary storage buffer 600 (see FIG. 3B) explained later. The controller CL saves, according to the depression of the deposit and cash total key 36c, the transaction data maintained and stored in the temporary storage buffer 600 in the transaction memory 500 (see FIG. 3A) explained later as sales data.

The bill exchange key 36a is a key for opening the drawer 15 when a customer requests for bill exchange.

The transaction suspension key 36b is a key for instructing, during commodity sales data processing for one transaction and after depression of the sub-total key 36d, suspension of the one transaction. When the controller CL determines that the transaction suspension key 36b is depressed, the controller CL suspends the one transaction being subjected to the commodity sales data processing. Suspension processing is executed by storing already input transaction data in the transaction memory 500 as transaction non-conclusion data. In this case, the controller CL does not store the transaction non-conclusion data in the transaction memory 500 as sales data but stores the transaction non-conclusion data in the transaction memory 500 as a history of some data input from the POS terminal 12.

The transaction suspension key 36b also has, as another function, a function of declaring, during an inspection and adjustment job, output of data in the illegal operation recording memory 700.

The transaction detail key has a function of declaring, during the inspection and adjustment job, output of sales data, transaction non-conclusion data explained later, or the like stored in the transaction memory 500.

The printer 40 is a receipt printer that can print transaction detail data of commodities input in one transaction on a receipt sheet and issue a receipt. The printer 40 print-outputs, during the inspection and adjustment job, sales data of a concluded transaction, transaction non-conclusion data, or the like stored in the transaction memory 500 and also print-outputs illegal operation data in the illegal operation recording memory 700 explained later.

The controller CL of the POS terminal 12 stores date and time when one transaction is started in the transaction date and time area 504 of the transaction memory 500 or prints the date and time on a receipt referring to date and time data measured by the clock unit 24. Further, the controller CL executes time-up determination or the like in various kinds of processing using a timing function of a timer 24a incorporated in the clock unit 24.

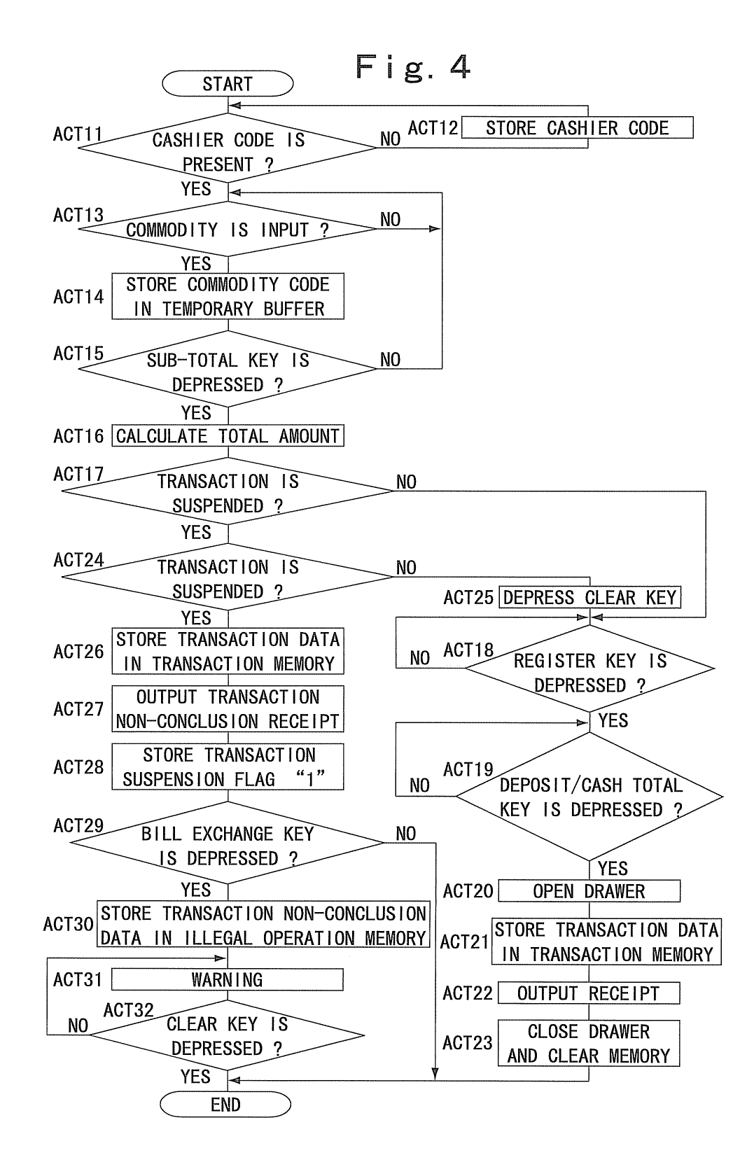

FIG. 4 is a flowchart of a flow of operations executed by the CPU 21 of the POS terminal 12 according to the control program and the like stored in the ROM 22. The POS terminal 12 requests a cashier to sign on to register a commodity. The sign-on is declared by, for example, scanning a barcode or the like affixed to a name plate or the like held on cloths of each of cashiers with the barcode scanner 37 or depressing the sign-on key after inputting a cashier code with the register key of the keyboard 35. The CPU 21 stores, according to the sign-on operation, a cashier code for specifying the cashier in the cashier code area 602 in the temporary storage buffer 600 shown in FIG. 3B (Act 12). Therefore, in Act 11, the CPU 21 determines whether the cashier code is stored in the cashier code area 602. If the CPU 21 determines that the cashier code is stored in the cashier code area 602 (YES in Act 11), the CPU 21 recognizes that the cashier signs on and executes Act 13.

The CPU 21 stands by for input of a commodity code of a commodity that a customer desires to purchase as one transaction (Act 13). For example, when the commodity code is input from the keyboard 35 or a barcode affixed to the commodity is scanned by the barcode scanner 37, the CPU 21 determines that a commodity is input (YES in Act 13). When the CPU 21 determines that the commodity is input, in Act 14, the CPU 21 stores the input commodity code in the transaction detail storage area 605 of the temporary storage buffer 600 as a commodity of the one transaction. The CPU 21 repeats the processing in Act 13 and Act 14 until the sub-total key 36d is depressed and all commodities desired to be purchased are input.

When the input of all the commodities that the customer desires to purchase is finished, the cashier depresses the sub-total key 36d. If the CPU 21 determines that the sub-total key 36d is depressed (YES in Act 15), in Act 16, the CPU 21 totals amount data stored in the transaction detail storage area 605 of the temporary storage buffer 600 and calculates a total amount. The CPU 21 displays the calculated total amount on the display for cashier 38 and the display for customer 39. The cashier informs the customer of the amount displayed on the display for cashier 38. The customer hands money exceeding the amount informed by the cashier to the cashier. The cashier inputs an amount of the received money using the register key (not shown) on the keyboard 35 and then depresses the deposit and cash total key 36c.

In Act 17 following Act 16, the CPU 21 determines whether the transaction suspension key 36b is depressed. If the CPU 21 does not determine the depression of the transaction suspension key 36b (NO in Act 17), the CPU 21 waits for register input of a deposit amount by the register key (not shown) (YES in Act 18) and depression of the deposit and cash total key 36c (YES in Act 19) and opens the drawer 15 in Act 20. Thereafter, in Act 21, the CPU 21 stores the transaction data stored in the temporary storage buffer 600 shown in FIG. 3B in the transaction memory 500 shown in FIG. 3A as sales data. In Act 22, the CPU 21 controls to drive the printer 40 and prints and issues a receipt. The cashier takes out a predetermined change amount from the drawer 15 on the basis of change data displayed on the display for cashier 38 and the display for customer 39 and hands the change amount to the customer together with the receipt. Thereafter, the cashier closes the drawer 15 to finish the one transaction and prepares for commodity input by the next customer. The CPU 21 checks closure of the drawer 15 and clears the transaction data stored in the temporary storage buffer 600 (Act 23).

Processing performed when the transaction suspension key 36b is depressed is explained below. If the CPU 21 determines that the transaction suspension key 36b is depressed (YES in Act 17), the CPU 21 determines whether the transaction suspension key 36b is depressed again (Act 18). If the CPU 21 determines in Act 17 that the transaction suspension key 36b is depressed (YES in Act 17), the CPU 21 displays a confirmation message such as “transaction is suspended, OK?” on a screen of the display for cashier 38 and determines whether the transaction suspension key 36b is depressed again (Act 18). When the cashier looks at the confirmation message and notices wrong operation, the cashier depressed the clear key (not shown) of the keyboard 35. If the CPU 21 does not determine that the transaction suspension key 36b is depressed again (NO in Act 18), when the clear key is depressed (Act 25), the CPU 21 executes the processing in Act 18 to Act 23.

When the transaction suspension key 36b is depressed again following the first depression of the transaction suspension key 36b in Act 17 (YES in Act 17 and YES in Act 18), the CPU 21 determines that the transaction is not concluded. The CPU 21 stores, according to the determination of the transaction non-conclusion, the transaction data stored in the temporary storage buffer 600 shown in FIG. 3B in the transaction memory 500 shown in FIG. 3C as transaction non-conclusion data (Act 26), executes printing and issuance of a transaction non-conclusion receipt by the printer 40 (Act 27), and stores, in a work area of the RAM 23, a transaction suspension flag “1” indicating that the transaction suspension operation is performed (Act 28). In Act 26, the transaction data is erased from the temporary storage buffer 600. In operation, the cashier keeps the transaction non-conclusion receipt output in Act 27 and hands the transaction non-conclusion receipt to a shop manager later. The shop manager uses the transaction non-conclusion receipt in, for example, a careful examination of sales data and money in the drawer 15 during the inspection and adjustment job.

In a state in which the CPU 21 determines that the transaction suspension key 36b is depressed twice (YES in Act 17 and YES in Act 18) and determines that the transaction is not concluded, the CPU 21 determines whether the bill exchange key 36a is depressed (Act 29). If the transaction is not concluded and the bill exchange key 36a is depressed, it is estimated that some illegal act is about to be committed. Therefore, if the CPU 21 determines in Act 29 that the bill exchange key 36a is depressed (YES in Act 29), the CPU 21 determines according to the determination of the transaction suspension flag “1” in Act 28 that illegal operation is performed and, in Act 30, stores the transaction non-conclusion data stored in the transaction memory 500 in the illegal operation recording memory 700 shown in FIG. 3C as illegal operation data. In storing the transaction non-conclusion data, the CPU 21 stores the data stored in the respective areas 501 to 504 of the transaction memory 500 in the respective areas 701 to 704 of the illegal operation recording memory 700 corresponding to the areas 501 to 504. Concerning transaction details in the transaction detail storage area 505, as an example, the CPU 21 stores only a total amount of the non-concluded transaction in the transaction suspension amount area 705. As another example, the CPU 21 stores the entire transaction details in the transaction suspension amount area 705. In Act 31, the CPU 21 executes warning. The warning is executed by, for example, displaying warning “Bill exchange operation cannot be performed. Please input a commodity again after depressing the clear key.” on the display for cashier 38 simultaneously with a warning sound.

As shown in FIG. 4, if the CPU 21 determines in Act 32 that the clear key is depressed (YES in Act 32), the CPU 21 finishes the processing. The CPU 21 repeats the warning until the CPU 21 determines in Act 32 that the clear key is depressed. Therefore, when the CPU 21 determines that the bill exchange key 36a is depressed in the state in which it is determined that the transaction suspension key 36b is depressed twice and the transaction is not concluded (YES in Act 17 and YES in Act 18), the CPU 21 prohibits opening of the drawer 15.

After determining in Act 32 that the clear key is depressed (YES in Act 32), if the CPU 21 determines that a commodity code is scanned by the barcode scanner 37 and input operation is performed on the keyboard 35, the CPU 21 changes the transaction suspension flag from “1” to “0”, erases the transaction data from the temporary storage buffer 600, and finishes the processing. Therefore, when input operation is performed on the barcode scanner 37 or the keyboard 35 as the commodity data input unit after the opening of the drawer 15 is prohibited, the CPU 21 releases the prohibition of the opening of the drawer 15. As another example, the CPU 21 may reset the transaction suspension flag to “0” when a power supply for the POS terminal 12 is turned off without changing the transaction suspension flag from “1” to “0” even if the CPU 21 determines that a commodity code is scanned by the barcode scanner 37 or input operation is performed on the keyboard 35.

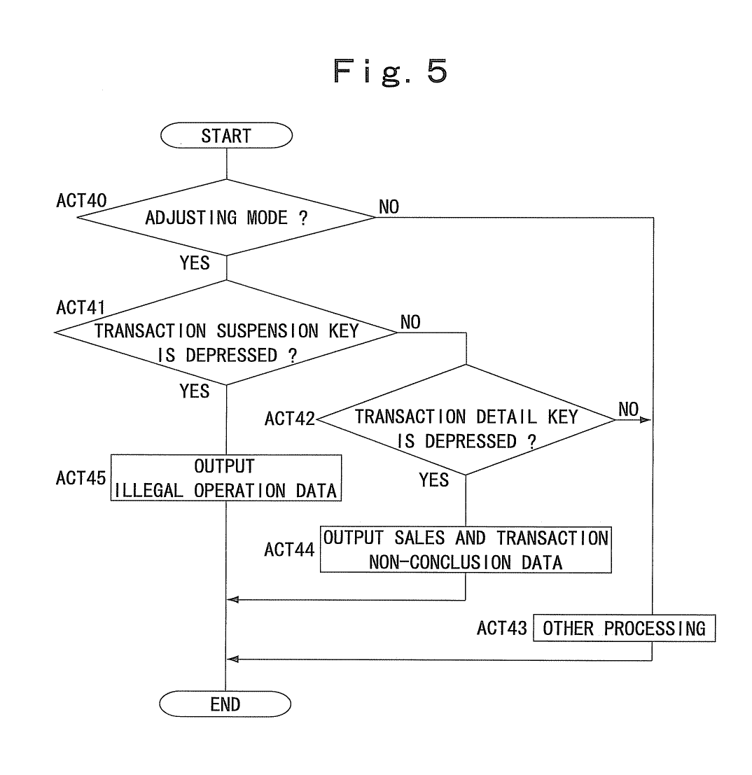

FIG. 5 is a flowchart of operations during an adjustment mode of the POS terminal 12. In order to perform the inspection and adjustment job in the POS terminal 12, for example, when the shop is inactive or when business in one day ends, the shop manager sets the POS terminal 12 in the adjustment mode. If the CPU 21 determines that the POS terminal 12 is in the adjustment mode (YES in Act 40), in Act 41, the CPU 21 determines whether the transaction suspension key 36b on the key board 35 is depressed. If the CPU 21 determines that the transaction suspension key 36b is depressed (YES in Act 41), the CPU 21 controls to drive the printer 40, print-outputs illegal operation data in the illegal operation recording memory 700 shown in FIG. 3C to a receipt sheet and finishes processing. As another example, if the CPU 21 determines that a dedicated key prepared separately from the transaction suspension key 36b, for example, an illegal operation output key (equivalent to YES in Act 41) is depressed, the CPU 21 may control to drive the printer 40 and print-output the illegal operation data in the illegal operation recording memory 700 shown in FIG. 3C to the receipt sheet.

When the illegal operation data in the illegal operation recording memory 700 shown in FIG. 3C is print-output to the receipt sheet, a receipt to be issued clearly indicates that the bill exchange key is depressed after transaction suspension. The CPU 21 also prints a POS number, a cashier code, a transaction number (a receipt number), suspension date and time, and a suspension amount on the receipt referring to the illegal operation data in the illegal operation recording memory 700.

As shown in FIG. 5, if the CPU 21 does not determine that the transaction suspension key 36b is depressed (NO in Act 41) and determines that the transaction detail key (not shown) is depressed (YES in Act 42), in Act 44, the CPU 21 controls to drive the printer 40 and print-outputs the sales data of the concluded transaction, the transaction non-conclusion data, and the like in the transaction memory 500 shown in FIG. 3A to a receipt sheet. If the CPU 21 does not determine either that the transaction suspension key 36b is depressed nor that the transaction detail key (not shown) is depressed (NO in Act 41 and NO in Act 42), in Act 43, the CPU 21 executes other processing.

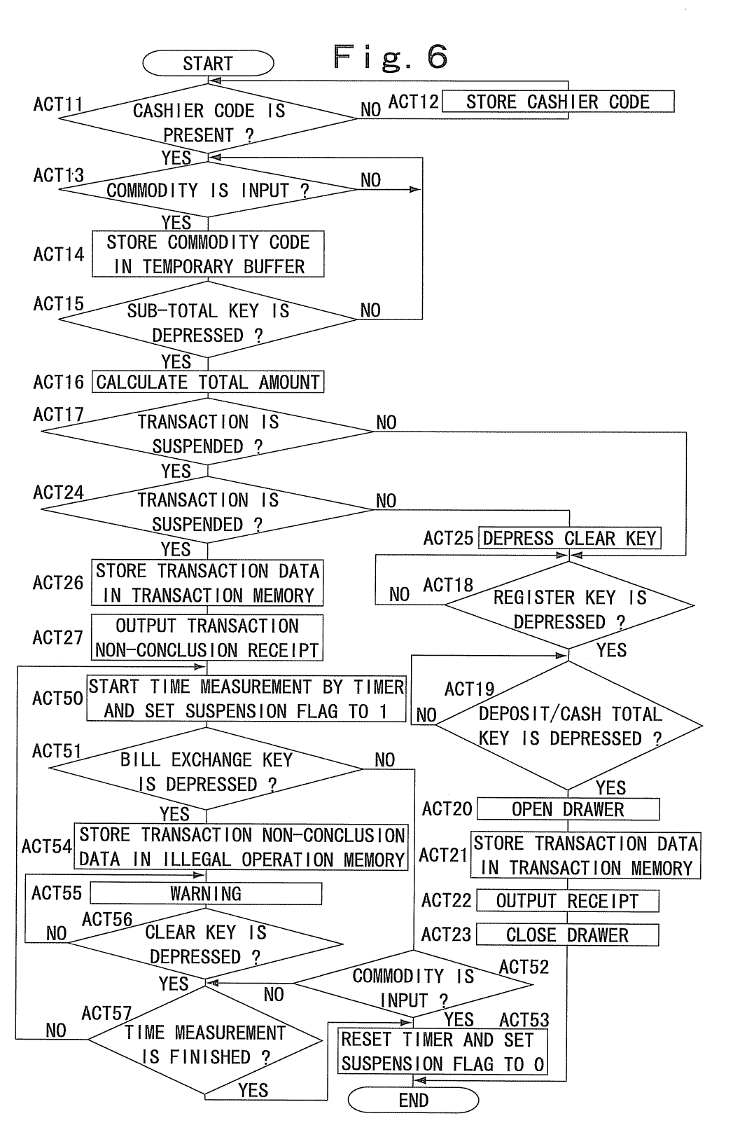

FIG. 6 is a flowchart of another example of operations executed by the CPU 21 of the POS terminal 12 in the registration mode. As another embodiment, the CPU 21 may execute processing in Act 50 to Act 57 shown in FIG. 6 instead of the processing in Act 27 to Act 32 shown in FIG. 4. The processing in Act 50 to Act 57 is processing for allowing, using the timer 24a of the clock unit 24, the cashier to shift to a transaction of the next customer according to expiration of a predetermined time even when transaction suspension is declared by pressing the transaction suspension key 36b twice. The processing is explained in detail below.

If the CPU 21 determines that the transaction suspension key 36b is depressed twice (YES in Act 24), the CPU 21 stores transaction non-conclusion data in the transaction memory 500 shown in FIG. 3A (Act 26) and prints and issues a transaction non-conclusion receipt (Act 27). Thereafter, in Act 50, the CPU 21 starts time measurement by the timer 24a and sets the transaction suspension flag to “1”. Measurement time by the timer 24a is, for example, five minutes. The measurement time is set to five minutes because it is unlikely that a cashier depresses the bill exchange key 36a and embezzles money after suspending a transaction and keeping a customer waited for five minutes or more. If commodity input of the next customer is performed before expiration of five minutes (YES in Act 52), in Act 53, the CPU 21 resets the timer 24a, resets the transaction suspension flag to “0”, and finishes the processing. If the CPU 21 determines that commodity input is performed (YES in Act 52), the CPU 21 also clears the transaction data stored in the temporary storage buffer 600 shown in FIG. 3B.

If the CPU 21 determines that the bill exchange key 36a is depressed during the time measurement of the timer 24a in Act 50 (YES in Act 51), the CPU 21 stores the transaction non-conclusion data stored in the transaction memory 500 shown in FIG. 3A in the illegal operation recording memory 700 shown in FIG. 3C as illegal operation data (Act 54). In this case, the CPU 21 directly stores the POS number, the cashier code, the transaction number, and the transaction date and time stored in the transaction memory 500 in the POS number area 701, the cashier code area 702, the transaction suspension number area 703, and the transaction suspension date and time area 704 of the illegal operation recording memory 700. On the other hand, the CPU 21 stores only the total amount data stored in the transaction detail storage area 505 in the transaction suspension amount area 705. This control is control from a viewpoint that the shop manager only has to be capable of grasping a total amount that is about to be embezzled. It goes without saying that the CPU 21 does not open the drawer 15 even if the bill exchange key 36a is depressed in Act 29.

Thereafter, the CPU 21 executes warning in Act 55 (see FIG. 7) and repeats the warning until the clear key (not shown) is depressed in Act 56. If the CPU 21 determines that the clear key is depressed (YES in Act 56), in Act 57, the CPU 21 determines whether the time measurement of the timer 24a is finished. If the CPU 21 determines that the bill exchange key 36a is depressed again during the time measurement of the timer 24a, the CPU 21 repeats the processing in Act 54 to 56.

If the CPU 21 determines in Act 57 that the timer 24a expires or determines in Act 52 that a commodity is input (re-input or input of a commodity that the next customer desires to purchase) before the expiration of the timer 24a (YES in Act 52), in Act 53, the CPU 21 resets the timer 24a, resets the transaction suspension flag to “0”, clears the transaction data stored in the temporary storage buffer 600, and finishes the processing.

In such a configuration, after sign-on, the cashier inputs commodities that a customer desires to purchase and, after inputting all the commodities, depresses the sub-total key 36d. When the sub-total key 36d is depressed, a total amount is displayed on the display for customer 39. The customer hands an amount same as or higher than the total amount to the cashier. If the cashier considers embezzling the paid amount, the cashier depresses the transaction suspension key 36b twice and declares suspension of transaction. Consequently, the POS terminal 12 prints and issues a transaction non-conclusion receipt. Thereafter, the cashier intending to commit an illegal act depresses the bill exchange key 36a. On the other hand, the POS terminal 12 prohibits opening of the drawer 15 that should be opened according to the depression of the bill exchange key 36a. Therefore, the POS terminal 12 can prevent embezzlement of money by the cashier intending to commit an illegal act.

Moreover, the POS terminal 12 stores the illegal operation data in the illegal operation recording memory 700 shown in FIG. 3C. Therefore, even if the cashier who performs illegal operation discards the transaction non-conclusion receipt to destroy the evidence, the shop manager can easily grasp, referring to the illegal operation data in the illegal operation recording memory 700, that the illegal operation is performed.

As another example of the commodity sales data processing system according to this embodiment, the illegal operation recording memory 700 shown in FIG. 3C may be provided in the host store server 14. If the CPU 21 of the POS terminal 12 determines that the transaction suspension key 36b of the keyboard 35 is depressed twice and then the bill exchange key 36a is depressed (Act 29 in FIG. 4 and Act 51 in FIG. 6), the CPU 21 transmits the illegal operation data to the illegal operation recording memory 700 provided in the store server 14. The store server 14 stores the received illegal operation data in the illegal operation recording memory 700. The store server 14 is connected to another store server to be capable of freely communicating data. Therefore, the store server 14 transmits the received illegal operation data to the other store server.

Contents displayed on the store server 14 in this embodiment are explained below. For example, it is assumed that, as explained above, the bill exchange key 36a is depressed after the transaction suspension key 36b is depressed in the POS terminal 12 specified by a POS number “03” among the POS terminals 12 in a shop specified by a shop number “123”. It is also assumed that a cashier is specified by a cashier code “012”, a receipt is specified by a transaction number “0145”, date and time of one transaction in which illegal operation is performed is “Mar. 26, 2008, 15:33”, and an amount that the cashier attempts to embezzle is “10,500 JPY”. Under such assumptions, when the store server 14 receives illegal operation data from the POS terminal 12 specified by the POS number “03”, the store server 14 receives the illegal operation data in which the POS number “03”, the cashier code “012” of the cashier, the transaction number “0145” equivalent to a receipt number, the date and time “Mar. 26, 2008, 15:33” of the one transaction in which the illegal operation is performed, and the amount “10,500 JPY” that the cashier attempts to embezzle. The store server 14 stores the received illegal operation data in the illegal operation recording memory 700. As an example, the store server 14 displays the information explained above together with warning “illegal operation occurs” on a display (not shown) of the store server. As another example, the store server 14 may output the illegal operation data with a method such as print out.

As explained above, the store server 14 transmits the received illegal operation data to another store server. For example, when illegal operation is performed in a large shop that manages shops such as franchise shops, a shop manager can watch illegal operation on a real time basis on a display screen of another store server connected to the store server 14.

Obviously, numerous modifications and variations of the present invention are possible in light of the above teachings. It is therefore to be understood that within the scope of the appended claims, the invention may be practiced otherwise than as specifically described herein.

What is claimed is:

1. A commodity sales data processing apparatus comprising:
a commodity-data input unit for inputting data concerning a commodity;
an operation input unit for inputting data;
a first data storing unit that stores data;
a second data storing unit that saves data; and
a controller that executes processing for:
outputting, in response to opening operation in the operation input unit, an opening command to a cash storing unit that can be freely opened and closed to store cash and opens according to the opening command;
storing, in the first data storing unit, transaction data for one transaction corresponding to input operation in the commodity-data input unit;
saving, when the one transaction is concluded, the transaction data stored in the first data storing unit in the second data storing unit as sales data;
saving, when the one transaction is suspended, the transaction data stored in the first data storing unit in the second data storing unit as transaction non-conclusion data; and
prohibiting opening of the cash storing unit when opening operation is performed in the operation input unit in a state in which the one transaction is suspended.

2. The apparatus of claim 1, wherein the controller saves, when the opening operation in the operation input unit is performed in the state in which the one transaction is suspended, the transaction non-conclusion data in the second data storing unit as illegal operation data.

3. The apparatus of claim 1, wherein the controller executes warning when the opening operation is performed in the operation input unit in the state in which the one transaction is suspended.

4. The apparatus of claim 1, wherein the controller further executes processing for:
measuring, when the opening operation is performed in the operation input unit in the state in which the one transaction is suspended, time after the opening operation; and
releasing, when the measured time reaches a fixed time, the prohibition of the opening of the cash storing unit.

5. A computer-readable medium having a computer program stored thereon that, when executed by a computer, causes the computer to:
output, in response to opening operation in an operation input unit for inputting data, an opening command to a cash storing unit that can be freely opened and closed to store cash and opens according to the opening command;
store, in a first data storing unit that stores data, transaction data for one transaction corresponding to input operation in a commodity-data input unit for inputting data concerning a commodity;
save, when the one transaction is concluded, the transaction data stored in the first data storing unit in a second data storing unit, which saves data, as sales data;
save, when the one transaction is suspended, the transaction data stored in the first data storing unit in the second data storing unit as transaction non-conclusion data; and
prohibit opening of the cash storing unit when opening operation is performed in the operation input unit in a state in which the one transaction is suspended.
